(19) United States
(12) Patent Application Publication
(10) Pub. No.: US 2001/0049245 A1
(43) Pub. Date: Dec. 6, 2001

(54) Safety pouch for high pressure gas cylinders

(76) Inventors: Roger Soar, Kelowna (CA); Ian Swan, Kelowna (CA)

Correspondence Address: John S. Reid, 1926 S. Valleyview Lane, Spokane, WA, 99212-0157, US

(21) Appl. No.: 09/861,244

(22) Filed: May 18, 2001

Related U.S. Application Data
(60) Provisional application No. 60/205,078, filed on May 18, 2000.

(51) Int. Cl. B32B 5/02; B32B 27/04; B32B 27/12; D03D 15/00; B32B 5/08; B32B 27/02

(52) U.S. Cl. 442/135; 442/181; 442/220; 428/911

(57) ABSTRACT

A safety pouch for high pressure gas cylinders includes an envelope of gas permeable ballistic fabric defining a cavity between walls of the envelope. The walls of the envelope are fastened together by discrete fasteners so as to form a gas escape passageway between the walls and the discrete fasteners. Thus gas escaping from a ruptured high pressure gas container mounted in the cavity passes along the passageway, so as to exit the envelope from between ends of the walls, and through the ballistic fabric of the walls.

### CROSS REFERENCE TO RELATED APPLICATION

This application claims priority from U.S. provisional patent application No. 60/205,078 filed May 18, 2000 entitled CO₂ Cartridge Safety Pouch.

### FIELD OF THE INVENTION

This invention related to a safety pouch for a high-pressure gas cartridge such as a CO₂ gas cartridge, and in particular, a safety pouch which provides for the safety of a user wearing such as a life jacket in the event that the gas cartridge used to inflate the life jacket is ruptured as for example by small calibre ballistic projectiles.

### SUMMARY

As used herein, the specific example of a carbon dioxide high pressure gas cartridge used in association with the inflation of life jackets is by way of example only and not intended to be limiting. It is specifically intended that the safety pouch of the present invention may be used, as would be understood to one skilled in the art, to protect a user upon the rupturing by ballistic penetration of other relatively small high-pressure gas cartridges, canisters or cylinders, as for example the oxygen supply canisters provided for pilot safety upon ejection from a flight cockpit. Consequently wherever the example is used herein of a CO₂ cartridge, such a reference is intended to include other relatively small high-pressure gas cartridges, canisters or cylinders.

Thus in one embodiment exemplifying the present invention, a CO₂ inflatable life jacket, configured to fit tactical bullet resistant vests, was tested to determine its ballistic integrity and safety for the user in the event the jacket's CO₂ cylinder was impacted by a bullet. A Kevlar fabric pouch effectively restrained the cylinder when the cylinder was ruptured by a bullet.

In summary, the safety pouch for high pressure gas cylinders of the present invention includes an envelope of gas permeable ballistic fabric defining a cavity between walls of the envelope. The walls of the envelope are fastened together by discrete fastening means so as to form a gas escape passageway between the walls and the discrete fastening means. Thus gas escaping from a ruptured high pressure gas container mounted in the cavity passes along the passageway, so as to exit the envelope from between ends of the walls, and through the ballistic fabric of the walls.

The discrete fastening means may be disposed along walls of the envelope extending oppositely from opposite sides of the cavity. The fastening means may be bar tacks. The bar tacks may be of stitching having a tensile strength less than a tensile strength of the ballistic fabric. The discrete fastening means may be a staggered array of discrete fasteners.

The ballistic fabric may be woven aramid fibre cloth. The envelope may be a single unitary sheet of the ballistic fabric folded over to form the walls in opposed facing relation. The cavity may be rectangular and deformable into a cylindrical shape and sized to snugly fit over the gas container when mounted in the cavity. The cavity may have only one open end adjacent an edge of the envelope.

The safety pouch may include a securing flap mounted to the envelope. The flap is for releasable mounting over an exposed end of the gas container when mounted in the cavity. The securing flap may be flexible and have an aperture therein for sliding fitment over a nipple of the gas container on the exposed end of the gas container when the flap is folded over so as to cover an opening of the cavity. The open end of the cavity may also be releasably closeable by a releasably closeable cover so as to retain the gas container in the cavity.

### BRIEF DESCRIPTION OF THE DRAWINGS

FIG. 1 is a perspective view of the containment pouch of the present invention.

FIG. 2 is an orthographic front elevation view of the pouch illustrated in FIG. 1.

FIG. 3 is a sectional view taken on line 3-3 of FIG. 2.

FIG. 4 is a sectional view taken on line 4-4 of FIG. 2.

FIG. 5 is an enlarged a perspective view of a pressurized CO₂ cylinder after impact by a small arms projectile.

FIG. 6 illustrated the containment pouch attached to a CO₂ manifold.

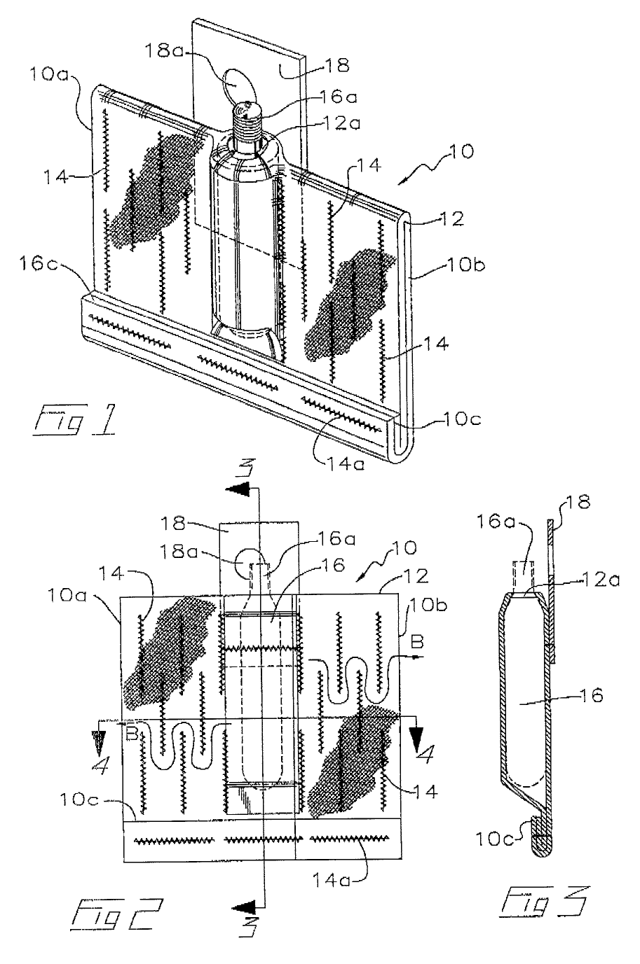

### DETAILED DESCRIPTION OF EMBODIMENTS OF THE INVENTION

Ballistic tests were conducted using a 9 mm 124 grain FMJ at velocities of 450 m/s. It was found that at these velocities such a bullet easily penetrated a pressurized CO₂ cylinder containing a 33 gram load of CO₂ specified for use in an inflatable life jacket.

Two sets of cylinders were shot over the course of the study. The first set was manufactured in either March 1995 or October 1996 and has a gross weight of 134.0 grams. The second set of cylinders were manufactured in June 1998 and has a gross weight of 138.0 grams. The cylinders were strapped to a target butt or backstop and impacted dead center.

The cylinders during the testing of the first set would spin off the target butt as a result of the impact and fall to the ground at the base of the butt. Examination of the cartridge found that the bullet has passed through both sides of the cylinder leaving two small holes (ingress and egress holes). It was noted that the membrane across the neck of the cylinder was bulging outwardly and had been ruptured. After shooting several cylinders without a cylinder manifold attached, the cylinder manifold was screwed onto the cylinder, as would be found in use such as on a CO₂ inflatable collar or vest, before the shot. The assembled cylinder was impacted again dead center.

The results from this test were markedly different from the previous test as the cylinders ruptured down the length of the cylinder and propelled themselves 15 feet down range. After examining the cylinders it was noted that the rupture membrane was still intact having been supported by the manifold. As the increased pressure generated by the impact could not escape via the rupture membrane, the cylinder walls themselves ruptured before the far wall of the cylinder was punctured by the bullet. Consequently there was no clear egress hole. Such a ruptured cylinder is illustrated in FIG. 5. A containment pouch was therefore required.

One embodiment of such a pouch is illustrated in the accompanying figures. In that embodiment an envelope 10 of ballistic fabric or of other high tensile strength woven fabric (collectively referred to a ballistic fabric) is constructed by folding a single ply sheet of woven aramid fibre cloth along fold line 12. The fabric may be such as sold under the trademark Kevlar by Dupont™ of Richmond, Va. In particular the fabric may be 3000 denier plan weave, 17 by 17 ends per inch, Kevlar™ 49. This is not intended to be limiting, as other woven ballistic fabrics would work so long as they have a sufficiently high tensile strength and a sufficiently loose weave or other means of gas permeability so that rapid gas expansion from a ruptured high pressure gas cylinder may pass in part through the fabric radially outwardly of the cylinder. Other examples, not intended to be limiting, include other strengths or forms of Kevlar™ (woven aramid fibre) fabric, woven Spectra™ (UHMW polyethelene), and Zylon™ (Poly(p-phenylene-2,6-benzo bisozazole) fabrics. The sides 10a and 10b of the envelope 10 are closed with a series of staggered sewn bar tacks 14 having a stitch density of approximately 20 stitches per inch. The thread used for bar tacks 14 may be nylon thread such as CBB69, 720 denier 3 ply bonded nylon thread having 11.9 lbs tensile strength. This again is not intended to be limiting. Other threads would work, and in some embodiments consistent with one aspect of the present invention the limiting property would be that the tensile strength of the threads be less than the tensile strength of the ballistic fabric so that bar tacks 14 fail before the ballistic fabric. In this fashion the bar tacks fail for example one at a time or serially, progressively outwardly of the ruptured or rupturing cylinder 16 thereby absorbing the energy of the expanding gas which would otherwise be dissipated into the ballistic fabric and the user.

It is also not intended that the use of bar backs be limiting as other fastening means would likely work. For example, the plies of ballistic fabric might be fastened together by adhesive, chemical, or heat (welding or other localized melting) treatments, or by other forms of mechanical fastening, or by lamination or other forms of bonding, attraction, adhesion, clamping, stitching in any form or shape, advantageously without introducing fragmentation material that would not be contained within the envelope along with the fragmentation (sharp edges, shards etc.) from the ruptured cylinder.

Fold 12 has aperture 12a through which the neck 16a of a pressurized CO₂ cylinder 16 or the like, (shown in dotted outline), can protrude. The remaining side 10c of envelope 10 is folded over so as to stimulate the tensile strength properties of fold 12, and closed with a series of bar tacks 14a after insertion of cylinder 16. Advantageously aperture 12a may be formed by pulling the weave of the fabric apart so as to form a sufficiently large hole. In this fashion no strands of the fabric are severed so as to not reduce the local tensile strength of the fabric and to decrease the likelihood of higher stress concentrations forming in the fabric than otherwise would around neck 16a of the cylinder.

A webbing flap 18 having aperture 18a formed therein is secured to the rear surface of envelope 10 by a suitable bar tack. Webbing 18 provides additional security by permitting the envelope to be attached to the valve stem 20 of a CO₂ manifold (not shown). Valve stem 20 of the CO₂ manifold is inserted through aperture 18a of webbing flap 18, the manifold is then relocated and secured with a cap nut 24 such as schematically illustrated in FIG. 6.

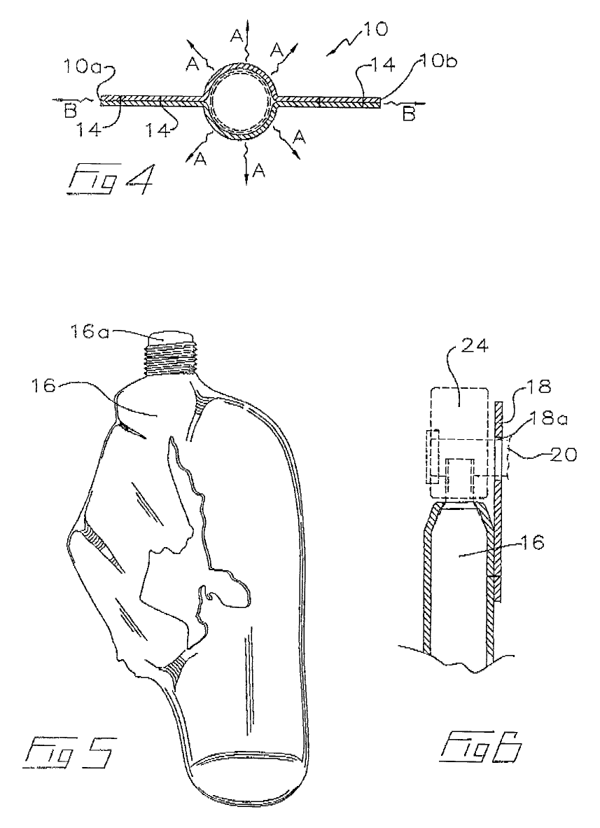

When a cylinder 16 (shown in dotted outline in FIG. 4) within the envelope 10 is impacted, the escaping gases easily pass through both the open weave of the fabric such as in radial direction A and between the bar tacks such as in direction B. The bar tacks are sewn with an appropriate stitch density so that they fail before the fabric and assist in absorbing the shock of the expanding gas. The ruptured cylinder is thus held contained within the Kevlar envelope.

The Kevlar envelope may be serged to prevent edge fraying and placed within a thin nylon cover (not shown). The entire package lies flat on the inflatable vest which is rolled up and used as normal.

As will be apparent to those skilled in the art in the light of the foregoing disclosure, many alterations and modifications are possible in the practice of this invention without departing from the spirit or scope thereof. For example, various numbers of layers may form the pouch as appropriate for the type and size of gas canister, that is, as appropriate to contain the canister upon rupture.

What is claimed is:

1. A safety pouch for high pressure gas cylinders comprising an envelope of gas permeable ballistic fabric defining a cavity between walls of said envelope, said walls of said envelope fastened together by discrete fastening means so as to form a gas escape passageway between said walls and said discrete fastening means so that gas escaping from a ruptured high pressure gas container mounted in said cavity passes along said passageway, so as to exit said envelope from between ends of said walls, and through said ballistic fabric of said walls.

2. The device of claim 1 wherein said discrete fastening means are disposed along walls of said envelope extending oppositely from opposite sides of said cavity.

3. The device of claim 1 wherein said fastening means are bar tacks.

4. The device of claim 2 wherein said fastening means are bar tacks.

5. The device of claim 3 wherein said bar tacks are of stitching having a tensile strength less than a tensile strength of said ballistic fabric.

6. The device of claim 4 wherein said bar tacks are of stitching having a tensile strength less than a tensile strength of said ballistic fabric.

7. The device of claim 1 wherein said discrete fastening means are a staggered array of discrete fasteners.

8. The device of claim 7 wherein said staggered array of discrete fasteners extends oppositely of said cavity oppositely along said walls.

9. The device of claim 7 wherein said fastening means are bar tacks.

10. The device of claim 9 wherein said bar tacks are of stitching having a tensile strength less than a tensile strength of said ballistic fabric.

11. The device of claim 1 wherein said ballistic fabric is woven aramid fibre cloth.

12. The device of claim 3 wherein said ballistic fabric is woven aramid fibre cloth.

13. The device of claim 5 wherein said ballistic fabric is woven aramid fibre cloth.

14. The device of claim 7 wherein said ballistic fabric is woven aramid fibre cloth.

15. The device of claim 1 wherein said envelope is a single unitary sheet of said ballistic fabric folded over to form said walls in opposed facing relation.

16. The device of claim 1 wherein said cavity is rectangular and deformable into a cylindrical shape and sized to snugly fit over said gas container when mounted in said cavity.

17. The device of claim 1 further comprising a securing flap mounted to said envelope, said flap for releasable mounting over an exposed end of said gas container when mounted in said cavity.

18. The device of claim 17 wherein said securing flap is flexible and has an aperture therein for sliding fitment over a nipple of said gas container on said exposed end of said gas container when said flap is folded over so as to cover an opening of said cavity.

19. The device of claim 1 wherein said cavity is deformable into a cylindrical shape and has one open end adjacent an edge of said envelope.

20. The device of claim 19 wherein said open end is releasably closeable by a releasably closeable cover so at to retain said gas container in said cavity.
